(19) United States
(12) Patent Application Publication
(10) Pub. No.: US 2013/0132883 A1
(43) Pub. Date: May 23, 2013

(54) Apparatus and Associated Methods

(71) Applicant: Jarno Tapio Vayrynen, Kempele (FI)

(72) Inventor: Jarno Tapio Vayrynen, Kempele (FI)

(73) Assignee: Nokia Corporation

(21) Appl. No.: 13/302,274

(22) Filed: Nov. 22, 2011

(51) Int. Cl. G06F 3/048

(52) U.S. Cl. 715/773; 715/830

(57) ABSTRACT

An apparatus including at least one processor; and at least one memory including computer program code, the at least one memory and the computer program code configured to, with the at least one processor, cause the apparatus to perform at least the following: detect a particular user input from a user interface of an electronic device, the particular user input being associated with a list of items; and use the detected particular user input to provide for scrolling through a filtered sub-set of the list of items.

### TECHNICAL FIELD

The present disclosure relates to the field of providing user input to a device, associated methods, computer programs and apparatus. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs) and tablet PCs.

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/e-mailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Electronic devices may enable a user to interact with a device via a user interface. Electronic devices may also allow a user to interact with a list of items, such as a list of e-mails, a list of entries in an address book, a list of songs, or a list of albums or books. A user may be able to scroll through the items in a list.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect, there is provided an apparatus comprising at least one processor; and at least one memory including computer program code, the at least one memory and the computer program code configured to, with the at least one processor, cause the apparatus to perform at least the following:

detect a particular user input from a user interface of an electronic device, the particular user input being associated with a list of items; and

use the detected particular user input to provide for scrolling through a filtered sub-set of the list of items.

The filtered sub-set may comprise a sub-set of the list of items in which particular items have been excluded from the list of items in order to provide the sub-set, the exclusion of items determined according to a filtering criterion. That is, applying a filter according to a filtering criterion to a list of items results in a sub-set of the items of the original list being displayed. For example, filtering a list of received SMS messages (the list of items) from a particular sender (the filtering criterion) will show SMS messages received from that particular sender and exclude from the sub-set of the list of items all SMS messages in the list not received from that particular sender.

Filtered scrolling may be based upon a filtering criterion which is determined according to a property of at least one item in the list of items. Such a property of a list of received e-mails, for example, may be the date of receipt, the sender, a keyword in the subject, a keyword in the body of the e-mail, or the account to which the e-mail was sent (if the list of items includes e-mails from more than one account). For example, filtered scrolling of a list of received e-mails may involve filtering by sender, and scrolling through a sub-set of the list of e-mails, the sub-set containing only those e-mails received from the particular sender used as a filtering criterion.

The property of at least one item may comprise a property of at least one item in a list of items associated with an e-mail application, a contact list, an address book, a messaging application, a calendar, a microblogging application, a social networking application, a music application, a marketplace application, a television application, a movie application, a photo application, a navigating application, a dictionary application, an e-book application, or another application involving a list of items.

The particular user input may be a single continuous gesture made using the user interface. The single continuous gesture made as a particular user input instructs the apparatus to both filter a list of items and scroll through that filtered sub-set of the list of items. Thus a single continuous gesture may be made, as opposed to separate user inputs for filtering the list of items and for scrolling through a list of items (and possibly for unfiltering the sub-set of the list of items).

The particular user input may be a gesture which comprises one or more of a tap, a swipe, a slide, a press, a hold, a rotate gesture, a static hover gesture proximal to the device, a moving hover gesture proximal to the user interface of the device, bending at least part of the device, squeezing at least part of the device, a multi-finger gesture, tilting the device, or flipping the device. Such a gesture may be made by a user using their finger(s) to interact with a touch-sensitive display on a portable electronic device, for example.

The particular user input may be a non-gesture input comprising clicking or pressing a mouse button, pressing a physical key, pressing a physical button, rotating a wheel or moving a trackball. Such a gesture may be made by a user using a peripheral input device, such as a mouse, to click on a user interface element displayed on a desktop computer monitor, for example.

A filtering criterion may provide a sub-set of items, the sub-set of items comprising one or more of:

items relating to the same application;

items relating to the same recipient;

items relating to the same sender;

items comprising the same key word;

items relating to the same user;

items relating to the same subject; or

items being associated with the same importance level.

For example, items related to the same application may be a list of files which can be opened in different applications, such as word processing documents, spreadsheets, PDFs, photos etc. Items related to the same recipient may be e-mails sent to the same person, posts seen in a particular user's microblog page or social networking application.

Items related to the same sender may be a list of e-mails sent by one contact. Items related to the same key word may be tagged photos in a photo application, for example photos tagged as “sport”, “family”, “holidays” or “work” etc., or may be songs belonging to particular music genres or albums in a music player. Items related to the same user may be entries in a shared calendar application, where calendar entries for more than one user are shown together in one calendar. Items related to the same subject may be posts in a microblog relating to the same subject as marked with a hashtag. Items related to the same importance level may be tasks in a task manager application. It will be appreciated that there are many examples for each possible group and only a few examples are given here.

The apparatus may be configured to provide additional alphabetisation grouping of the sub-set of the list of items. That is, in addition to providing for filtered scrolling through a list of items, the apparatus may additionally provide for the further operation of grouping items in a list, or sub-set of a list, alphabetically. For example, a list of e-mails in an e-mail inbox may be filtered according to a keyword in a subject line of the e-mail, and scrolled through. Additionally, the e-mails in the filtered sub-set of the list of e-mails may also be grouped alphabetically, for example by the surname of the sender of each e-mail.

The particular user input may be associated with one or more particular locations on the user interface of the electronic device. The one or more particular locations may comprise one or more of columns, rows, or areas of the user interface of the electronic device. The one or more columns, rows, or areas may or may not be specifically visibly demarked on the user interface.

That is, a particular user input made on the left side, in a left-hand column, of a touch-sensitive screen of a device may be associated with filtering according to one filtering criterion and scrolling, whereas a particular user input made on the right side, in a right-hand column of the screen may be associated with a different particular user input and may be associated with filtering according to a different filtering criterion and scrolling, for example.

The user interface of the electronic device may comprise one or more of a touchpad, a touch-screen, a stylus and pad, a virtual keyboard, a virtual button, a symbol, a scriber, an accelerometer, a wand, a pointing stick, a mouse, a physical keyboard, a joystick, a remote controller, a physical button, a motion detector, or a position detector.

The user interface of the electronic device may comprise one or more user interface elements associated with receipt of the particular user input, the user interface element comprising an icon, a physical key, a menu item, or a particular region on a touch-sensitive user interface. An icon may be a graphical icon, including text symbol and/or avatar pictures. The physical key may be a physical key on a peripheral keyboard. For example, a portable electronic device with a touch-sensitive screen as a user interface may display a list of received SMS messages on the screen, along with a series of user interface elements. Each user interface element can be interacted with in order for the device to receive a particular user input. Each user interface element may be displayed as a button icon, for example, to show that region of the touch-sensitive screen can accept a particular user input to provide for a particular filtered scrolling.

A filtering criterion for filtering the list of items may be at least one of user selectable, or predetermined by the device. A user selectable filtering criterion, or criteria, may be considered as filtering criteria configured by the user on the apparatus. In the example of a social networking application the user may be able to select filtering criteria according to his or her own preference e.g. “friends”, “friends of friends” and “anyone”, and filter posts made by all the social network contacts based on these user-selected criteria. A filtering criterion or criteria may be determined by the apparatus/device. For example, if the apparatus runs a dictionary application, the apparatus may determine filtering criteria by automatically identifying, for example, the type of each entry (noun, verb, adverb, adjective, etc.) and allow the dictionary entries to be filtered based on the apparatus-determined filtering criteria. A filtering criterion may also be a combination of user selectable and predetermined by the apparatus. For example, the user may select preferred filtering criteria from a selection determined by the apparatus.

The apparatus may be an electronic device, a portable electronic device, a laptop computer, a desktop computer, a mobile phone, a Smartphone, a tablet computer, a monitor, a personal digital assistant, a digital camera, a watch, a server, or a module/circuitry for one or more of the same.

In another aspect, there is provided a method comprising:

detecting a particular user input from a user interface of an electronic device, the particular user input being associated with a list of items; and

using the detected particular user input to provide for scrolling through a filtered sub-set of the list of items.

In another aspect, there is provided a computer program comprising computer program code configured to:

detect a particular user input from a user interface of an electronic device, the particular user input being associated with a list of items; and

use the detected particular user input to provide for scrolling through a filtered sub-set of the list of items.

In another aspect, there is provided a computer readable medium comprising computer program code stored thereon, the computer readable medium and computer program code being configured to, when run on at least one processor, perform at least the following:

detect a particular user input from a user interface of an electronic device, the particular user input being associated with a list of items; and

use the detected particular user input to provide for scrolling through a filtered sub-set of the list of items.

In another aspect, there is provided an apparatus, the apparatus comprising:

means for detecting a particular user input from a user interface of an electronic device, the particular user input being associated with a list of items; and

means for using the detected particular user input to provide for scrolling through a filtered sub-set of the list of items.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1 illustrates an example according to the present disclosure;

FIGS. 2a-2c illustrate further examples;

FIG. 3 illustrates another example;

FIGS. 4a-4d depict an example embodiment showing a user performing filtered scrolling in an e-mail type application;

FIGS. 5a-5c depict an example embodiment showing a user performing filtered scrolling in a music player type application;

FIG. 6 illustrates an example embodiment comprising peripheral user interface elements;

FIGS. 7a-7b depict an example embodiment showing a user performing filtered scrolling in an address book type application;

FIG. 8 illustrates a flowchart according to a method of the present disclosure; and

FIG. 9 illustrates schematically a computer readable medium providing a program according to an embodiment of the present disclosure.

### DESCRIPTION OF EXAMPLE ASPECTS/EMBODIMENTS

Apparatus such as electronic devices may allow a user to interact with a list of elements or items displayed by the apparatus, such as a list of received e-mails, or a list of contact details in an address book.

Certain example embodiments described herein may be considered to provide for an efficient way of allowing a user to apply a filtering criterion to a list of items to allow the user to scroll through a filtered list, via a single user input. The actual scrolling through the filtered list could be provided by a separate user input of the same user input that provides for filtering. Example embodiments may provide advantages, such as a user only being required to provide one user input to both scroll through a list and apply a filter to the list. This ability to filter and scroll via a single continuous gesture, or single continuous user input, may allow for a more intuitive and straightforward way of managing and finding items in lists, and for working with (long) lists of items. This ability of using a single user input for both filtering and scrolling may also provide for a faster way of working with lists and identifying particular entries in lists.

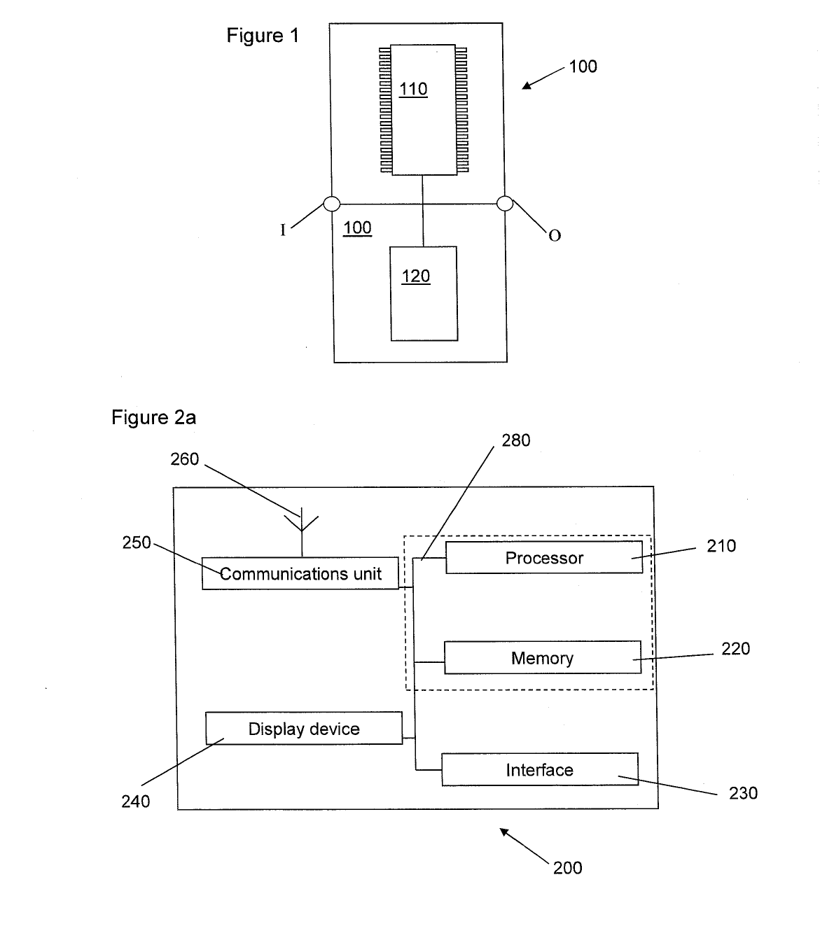

FIG. 1 shows an apparatus 100 comprising a processor 110, memory 120, input I and output O. In this embodiment only one processor and one memory are shown but it will be appreciated that other embodiments may utilise more than one processor and/or more than one memory (e.g. same or different processor/memory types).

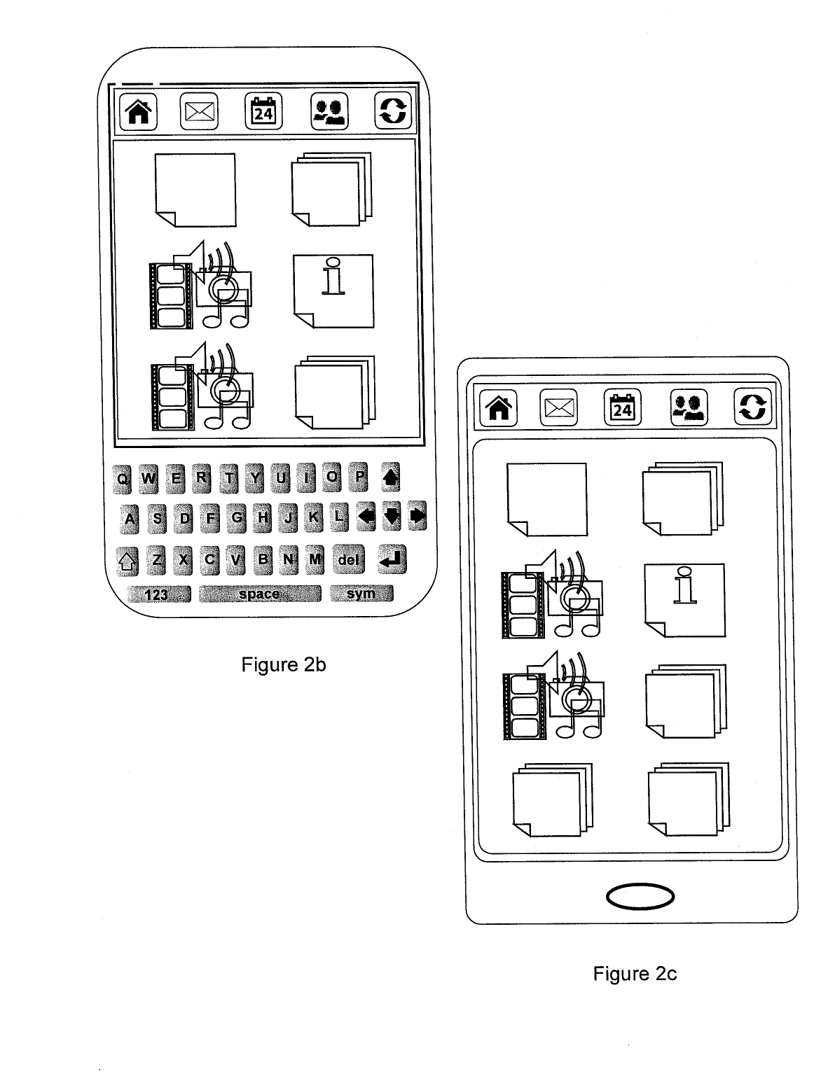

In this embodiment the apparatus 100 is an application specific integrated circuit (ASIC) for a portable electronic device 200 with a touch sensitive display 240 (as per FIGS. 2a-2c). In other embodiments the apparatus 100 can be a module for such a device, or may be the device itself, wherein the processor 110 is a general purpose CPU of the device 200 and the memory 120 is general purpose memory comprised by the device 200.

The input I allows for receipt of signalling to the apparatus 100 from further components, such as components of a portable electronic device 200 (like a touch-sensitive display 240) or the like. Such signalling may be a signal to the apparatus that a user has made a particular user input on a region of the touch-sensitive display 240 of the device 200. The output O allows for onward provision of signalling from within the apparatus 100 to further components. For example, the apparatus may signal to change the display of items in a list shown on the touch sensitive display 240 to output the results of a previous user input. In this embodiment the input I and output O are part of a connection bus that allows for connection of the apparatus 100 to further components.

The processor 110 is a processor dedicated to executing/processing information received via the input I in accordance with instructions stored in the form of computer program code on the memory 120. The output signalling generated by such operations from the processor 110 is provided onwards to further components via the output O.

The memory 120 (not necessarily a single memory unit) is a computer readable medium (solid state memory in this example, but may be other types of memory such as a hard drive, ROM, RAM, Flash or the like) that stores computer program code. This computer program code stores instructions that are executable by the processor 110, when the program code is run on the processor 110. The internal connections between the memory 120 and the processor 110 can be understood to, in one or more embodiments, provide an active coupling between the processor 110 and the memory 120 to allow the processor 110 to access the computer program code stored on the memory 120.

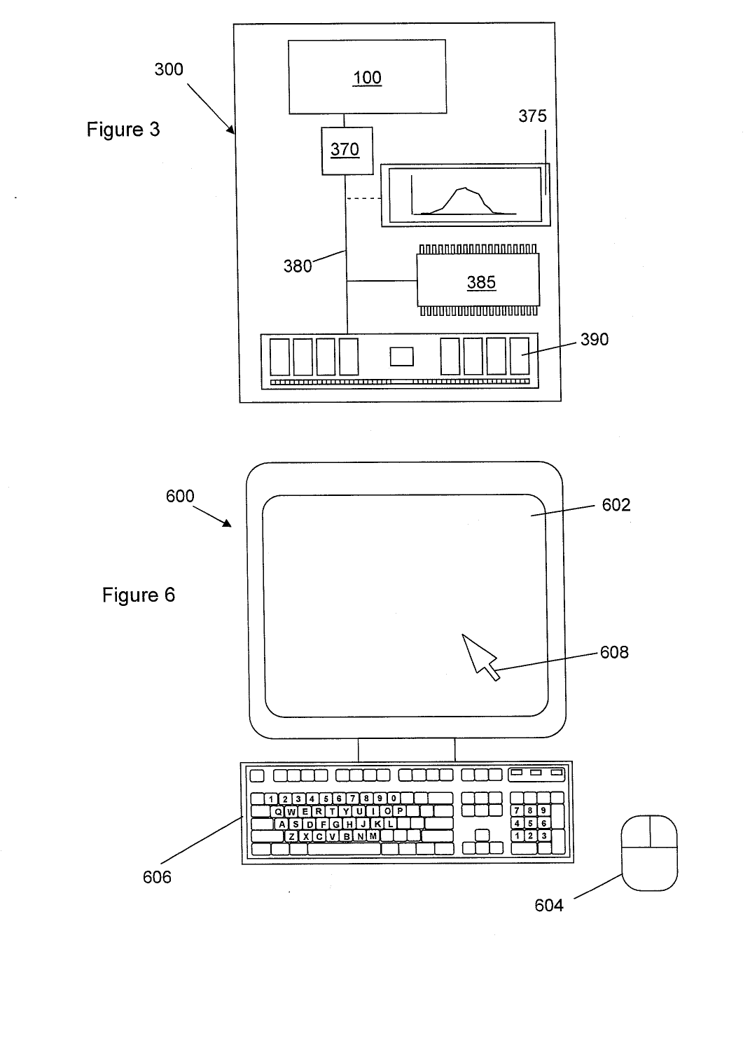

In this embodiment the input I, output O, processor 110 and memory 120 are all electrically connected to one another internally to allow for electrical communication between the respective components I, O, 110, 120. In this example the components are all located proximate to one another so as to be formed together as an ASIC, in other words, so as to be integrated together as a single chip/circuit that can be installed into an electronic device. In other embodiments one or more or all of the components may be located separately from one another (for example, throughout a portable electronic device like device 200 of FIG. 2a or device 300 of FIG. 3 and/or may provide/support other functionality, i.e. shared to provide different respective functionalities).

Other embodiments depicted in the figures have been provided with reference numerals that correspond to similar features of earlier described embodiments. For example, feature number 1 can also correspond to numbers 101, 201, 301 etc. These numbered features may appear in the figures but may not have been directly referred to within the description of these particular embodiments. These have still been provided in the figures to aid understanding of the further embodiments, particularly in relation to the features of similar earlier described embodiments.

One or more examples of the apparatus 100 discussed above can be used as a component for another apparatus or device such as in FIG. 2a (or, in a more specific example, like a PDA as per FIG. 2c). FIG. 2a can be understood to depict a variation of an apparatus 100 where the apparatus is a device 200 that incorporates the functionality of apparatus 100 spread throughout constituent components. In other example embodiments, the device 200 may comprise apparatus 100 as a module (shown by the optional dashed line box) for a mobile phone or PDA or audio/video player or the like. Such a module, apparatus or device may just comprise a suitably configured memory and processor (as per FIG. 1—see also the apparatus 100 within device 300 of FIG. 3).

In the example of FIG. 2a, the functionality offered by each of the components in the example of FIG. 1 is shared between other components and the functions of the device of FIG. 2a. In some examples the device 200 is actually part of a mobile communications device like a mobile telephone of FIG. 2b, PDA of FIG. 2c, tablet PC, laptop, or the like.

In this case, the device 200 comprises a display device 240 such as, for example, a Liquid Crystal Display (LCD) or touch-screen user interface. The device 200 is configured such that it may receive, include, and/or otherwise access data. For example, device 200 can comprise a communications unit 250, such as a receiver, transmitter, and/or transceiver, in communication with an antenna 260 for connecting to a wireless network and/or a port (not shown) for accepting a physical connection to a network, such that data may be received via one or more types of network. This example embodiment comprises a memory 220 that stores data, possibly after being received via antenna 260 or port or after being generated at the user input interface 230. The processor 210 may receive data from the user input interface 230, from the memory 220, or from the communication unit 250. Regardless of the origin of the data, these data may be outputted to a user of device 200 via the display device 240, and/or any other output devices provided with apparatus. The processor 210 may also store the data for later user in the memory 220.

In this case, the device 200 comprises processor 210, memory 220, input interface 230, display 240 (in certain embodiments, the input interface 230 and the display 240 may be combined, for example, via a touch sensitive display), communications unit 250, antenna 260 all connected together via communications bus 280. The communications unit 250 can be, for example, a receiver, transmitter, and/or transceiver, that is in communication with an antenna 260 for connecting to a wireless network and/or a port (not shown) for accepting a physical connection to a network, such that data may be received via one or more types of networks. The communications (or data) bus 280 can be seen, in one or more embodiments, to provide an active coupling between the processor 210 and the memory (or storage medium 220) to allow the processor 210 to access the computer program code stored on the memory 220.

The memory 220 comprises the computer program code in the same way as the memory 120 of apparatus 100, but may also comprise other data that can be useable by the (or other) processor/processors/memory/memories. For example, the memory 220 can (in some embodiments) be able to store other data, possibly after being received via antenna 260 or port or after being generated at the user interface 230. The processor 210 may receive data from the user interface 230, from the memory 220, or from the communication unit 250. Regardless of the origin of the data, these data may be outputted to a user of device 200 via the display device 240, and/or any other output devices provided with apparatus. The processor 210 may also store the data for later user in the memory 220.

As has been discussed, FIG. 2a illustrates schematically an apparatus/device 200 (such as a portable mobile telephone or portable electronic device) comprising the apparatus 100 (or functionality of the apparatus 100 distributed throughout its components) as described above. FIG. 3 illustrates another such implementation in device 300.

The device 300 may be an electronic device (including a tablet personal computer), a portable electronic device, a portable telecommunications device, or a module for any of the aforementioned devices. The apparatus 100 can be provided as a module for such a device 300, or even as a processor/memory for the device 300 or a processor/memory for a module for such a device 300. The device 300 also comprises a processor 385 and a storage medium 390, which are electrically connected to one another by a data bus 380. This data bus 380 can be seen to provide an active coupling between the processor 385 and the storage medium 390 to allow the processor 380 to access the computer program code.

The apparatus 100 is first electrically connected to an input/output interface 370 that receives the output from the apparatus 100 and transmits this onwards to the rest of the device 300 via data bus 380. Interface 370 can be connected via the data bus 380 to a display 375 (touch-sensitive or otherwise) that provides information from the apparatus 100 to a user. Display 375 can be part of the device 300 or can be separate.

The device 300 also comprises a processor 385 that is configured for general control of the apparatus 100 as well as the rest of the device 300 by providing signalling to, and receiving signalling from, the other device components to manage their operation.

The storage medium 390 is configured to store computer code configured to perform, control or enable the making and/or operation of the apparatus 100. The storage medium 390 may also be configured to store settings for the other device components. The processor 385 may access the storage medium 390 to retrieve the component settings in order to manage the operation of the other device components. The storage medium 390 may be a temporary storage medium such as a volatile random access memory. On the other hand, the storage medium 390 may be a permanent storage medium such as a hard disk drive, a flash memory, or a non-volatile random access memory. The storage medium 390 could be composed of different combinations of same or different memory types.

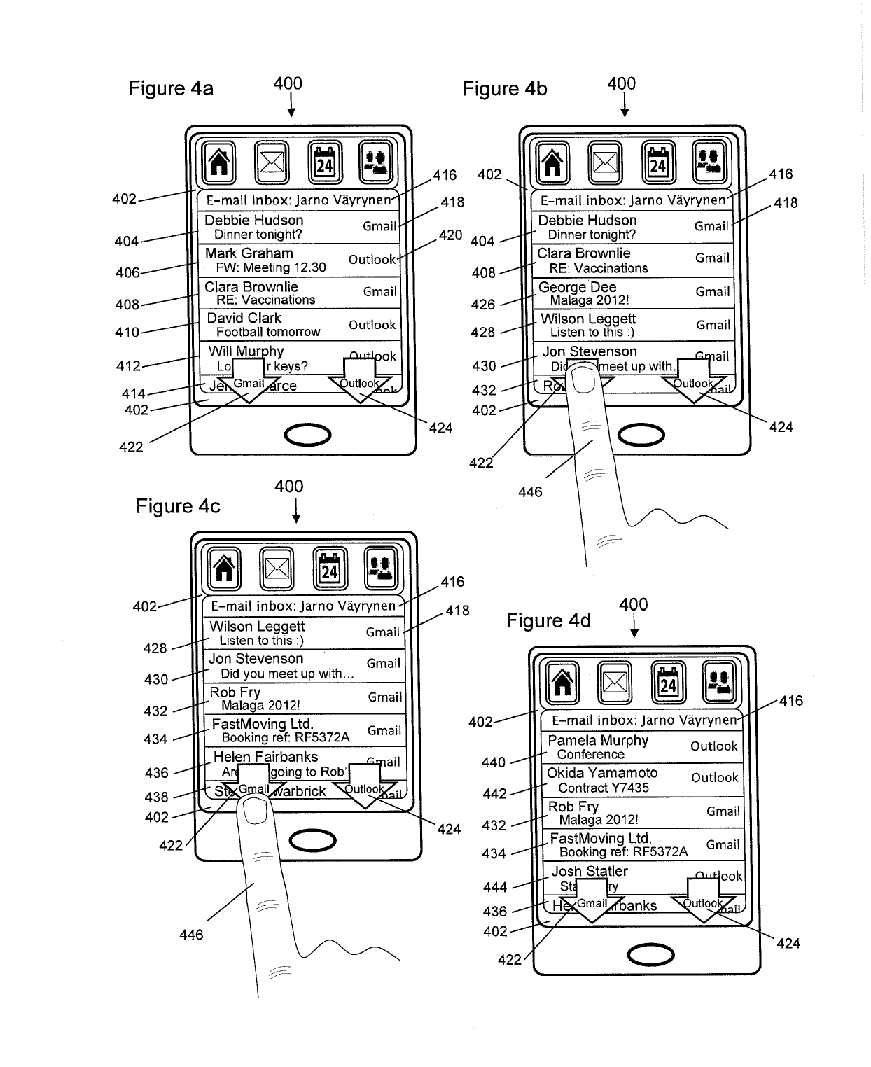

FIGS. 4a-d show an example embodiment of an apparatus which is a portable electronic device 400 in use. The portable electronic device 400 comprises a touch-sensitive screen (or touch-screen 402) which provides a user interface for the device. In this example, the device is displaying, on the touch-sensitive screen 402, a list of e-mails in an e-mail application. The list of e-mails displayed is a list of items.

FIG. 4a shows that the device 400 is displaying the unified e-mail inbox of an e-mail application for the device user, Jarno Väyrynen 416. In the unified e-mail inbox e-mails may be read and processed which have been received in different e-mail accounts which are linked to the unified e-mail inbox. A list of items, that is a list of e-mails from various third parties 404, 406, 408, 410, 412, 414 is displayed on the touch-sensitive screen 402 of the device 400. The user in this example has more e-mails available on the device than those seen in FIG. 4a but not all the e-mails can be seen at the same time. The user needs to scroll through the list of e-mails to see all the e-mails available.

The e-mail application in this example shows e-mails received by two different accounts: a Gmail account and an Outlook account. Each item in the list shows the account in which it was received. For example, the e-mail from Debbie Hudson 404 was received by the user's Gmail account 418, and the e-mail received from Mark Graham 406 was received by the user's Outlook account 420. It will be appreciated that in another example embodiment, each e-mail item displayed in the list of e-mails may not necessarily show which e-mail account it was received by. That is, labels such as “Gmail” 418 and “Outlook” 420 may not necessarily be displayed. In addition, it may be envisaged that the account label may be provided as an icon rather than a label in words, or via non-visual means. For example, audio output may be provided to let the user know which account an e-mail was received by. As a further example, differentiated haptic feedback may be provided to the user to differentially indicate which e-mail account an e-mail was received by.

In this example, the user wishes to find an e-mail which he knows was received in his Gmail account from FastMoving Ltd. The user is able to make a particular user input in the user interface of the electronic device at a particular location on the user interface in order to scroll through a filtered sub-set of the list of e-mails. The particular locations available are shown 422, 424 on the user interface, that is, on the touch-sensitive screen 402 and each location displays a user interface element. The two user interface elements, or indicators, located on the bottom left and bottom right of the screen each display an associated filtering criterion, either “Gmail” 422 or “Outlook” 424. The filtering criteria “Gmail” and “Outlook” are determined according a property of the items in the list, that is, the account to which each e-mail in the list of e-mail was sent. It may be envisaged that in this example, the apparatus has determined the filtering criteria based on the different e-mail accounts used in the unified e-mail application.

It will be appreciated that in other examples, the particular locations where a user may make particular user inputs need not be as shown in FIGS. 4a-4d. For example, other regions of the display, such as the top, or sides, or centre of the display may be configured to act as user interface elements where a user may make a particular user input to both filter and scroll through a list of items. It may be envisaged that the apparatus is configured to accept particular user inputs on the back, sides, or other region of the apparatus in order to perform filtered scrolling. Such areas may or may not be visibly demarked to show that they are available to perform filtered scrolling.

FIG. 4b shows that the user has begun a particular user input 446 by touching his finger 446 at the particular location 422 on the user interface. The particular user input allows the user to scroll through a filtered sub-set of the list of items (e-mails), the items in the subset having the property of being received by the user's Gmail e-mail account. E-mails from Debbie Hudson 404 and Clara Brownlie 408 form part of the sub-set of the list of items as they were received by the user's Gmail account. Other e-mails received in the user's Gmail inbox 426, 428, 430, 432 are shown in FIG. 4b which were not shown in FIG. 4a. E-mails not received by the user's Gmail account (such as those from Mark Graham 406 and David Clark 410, received by the user's Outlook account) are excluded from the sub-set of the list of items as shown in FIG. 4b.

FIG. 4b shows the user at the very beginning of providing a particular user input. FIG. 4c then shows the user continuing his particular user input 446 by sliding his finger down the user interface element arrow 422. The sub-set of the list of items displayed on the touch-sensitive screen 402 is being scrolled through as a result of the user providing a further, for example, particular user input (e.g. sliding his finger 446) down the user interface element (the Gmail arrow 422). FIG. 4b corresponds to the start of the particular user input and shows an e-mail from Debbie Hudson 404 at the top of the displayed sub-set of the list of items. In FIG. 4c, after some time has passed and the user has provided his (e.g. further) particular user input (of sliding his finger down the Gmail arrow) for longer than in FIG. 4b, the e-mail from Debbie Hudson 404 has moved off the top of the display and is no longer visible in FIG. 4c. E-mails in the filtered sub-set of the list of items which are displayed lower on the display in FIG. 4b are now displayed higher on the display in FIG. 4c, such as those e-mails received from Wilson Leggett 428 and Jon Stevenson 430. E-mails in the sub-set of the list of items which were not displayed in FIG. 4b, as they were too far down the list to be shown on screen, can now be seen 432, 434, 436, 438 in FIG. 4c since the scrolling has progressed. It can also be seen that the apparatus now displays (in FIG. 4c) the e-mail received from FastMoving Ltd. 434 which was the e-mail which the user wished to read.

FIG. 4d shows that the user has ended his (e.g. further) particular user input of sliding his finger 446 down the Gmail user interface element 422 and released his finger from the touch-sensitive screen 402. In this example, the apparatus has automatically removed the filter and so the full list of e-mails (only a portion of which may be shown at any time on the display, in this case 440, 442, 432, 434, 444, 436), rather than a sub-set, is available for display. However, since the user performed filtered scrolling in order to find an e-mail of interest 434 the apparatus continues to display the e-mail which was at the centre of the display before release of the particular user input after the input is released. In this way the user does not “lose his place” in the list and is able to then perform further interactions with the apparatus, such as, for example, tapping the e-mail item from FastMoving Ltd. in order to read it. In other embodiments, release of the user's finger may just show the filtered list of items as at the time of release.

The apparatus may also provide additional manipulation of the items in a sub-set of a list of items. An example is that if, rather than the filter being removed from the sub-set of the list of items as in FIG. 4d, the filter remains in place after release of the particular user input, the user may wish to manipulate the displayed entries further. The user in this example is able to provide an additional user input and order the e-mails in the sub-set of the list of items alphabetically. He may then be able to scroll through this alphabetised sub-set of the list of items. The apparatus may also allow the user to provide an additional user input to perform alphabetised grouping of the items displayed in the sub-set of the list of items and scroll through the sub-set items.

The filtering performed in this example means that the device excludes e-mails received in any account other than Gmail, as “Gmail” was the filtering criterion applied. Therefore e-mails received by the user's Outlook account 406, 410, 412, 414 are excluded from the filtered sub-set of the list of items. FIG. 4b shows that all the e-mails displayed are associated with the user's Gmail account 418. It can be seen that, compared with FIG. 4a, more e-mails from the user's Gmail account can be seen 426, 428, 430, 432 since the e-mails received by accounts other than the user's Gmail account are excluded from the list.

The particular user input of a user sliding his finger down 446 the user interface element of a Gmail arrow 422 has allowed the user to perform filtered scrolling through his list of e-mails in a single gesture. It will be appreciated that in this example, the filtering criterion may be considered to have provided a sub-set of items comprising items relating to the same application (the application criterion being “Gmail”), and a sub-set of items comprising items relating to the same keyword (the keyword criterion being “Gmail”).

It will be appreciated that in this example the term “slide” is used to describe the (e.g. further) particular user input used, of sliding a finger (or other object) over a touch sensitive screen, whereby the list is scrolled through at a rate proportional to the speed at which the user slides his or her finger (or other object), and that upon release of the user input, the device no longer scrolls through the list. The example embodiment may also work if a swipe (which may also be called a flick) is used as a particular user input. The term “swipe” (or “flick”) may refer to the action of quickly sliding/flicking a finger (or other object) over a touch-sensitive screen, with the effect of scrolling through the list relatively quickly and such that, after release of the swipe/flick, there is a period of time after the release of the swipe/flick whereby the device continues to scroll through the list for a predetermined period of time at a decelerating rate after the release until the scrolling stops. Also, in other embodiments, continuous depressing/input over region 422 may provide for continuous scrolling, and release of the input may provide for stopping the scrolling.

In the above example if the user wished to filter the list to show only e-mails received in his Outlook account, he could have provided a particular user input at the location displaying “Outlook” as a filtering criterion 424. It may be imagined that the user has more than two e-mail accounts. For example, the user may use his Gmail account as a personal e-mail account, whereas the user's Outlook account is the account used for work and business related correspondence. It may be envisaged that the user has a further e-mail account which he uses in relation to purchasing goods and services online, and/or an account which the user uses when interacting with weblog/blog internet sites, social network websites, internet forums or when commenting on internet sites.

Another example embodiment may have the user interface elements defined to be regions of the apparatus other than arrows displayed on a screen. One may envisage an example of an apparatus comprising a touch-sensitive screen, wherein at least a portion of the touch-sensitive screen is configured to accept particular user inputs at one or more locations on the portion of the touch-sensitive screen. For example, the portion of the screen may be split into columns or areas, whereby each column or area is configured to act as a particular region and can accept a particular user input to perform filtered scrolling through a sub-set of items of a list. Such columns or areas need not necessarily be indicated visually on the screen.

For example, an apparatus may display a list of all e-mails received by three e-mail accounts in a unified e-mail inbox on a portable electronic device. A user may be able to provide a particular user input on the left side of the touch-sensitive screen in order to scroll through a sub-set of e-mails matching the criterion “Gmail”, provide a particular user input in the centre of the display to scroll through a sub-set of e-mails matching the criterion “Outlook”, and provide a particular user input on the right side of the screen to scroll through a sub-set of e-mails matching the criterion “Hotmail”. The three areas in this example need not be three columns, but may instead by three horizontal areas across the touch-sensitive screen. The top area may correspond to filtered scrolling according to “Gmail” e-mails, the centre area may correspond to filtered scrolling according to “Outlook” e-mails, and the bottom area may correspond to filtered scrolling according to “Hotmail” e-mails, for example. Other combinations are of course possible.

The left, centre and right columns/areas (or top, middle and bottom strips/areas) of the display need not be marked as such by separating lines, or any labels being displayed on screen. One may consider such unmarked areas as ‘virtual’ columns/strips/areas. In some example embodiments, the ‘virtual’ columns/strips/areas defined to allow a user to make a particular user input may be highlighted to a user upon the user making a particular user input associated with that column/strip/area. The highlighting of the area may be made by the area where the input is made briefly changing colour, or flashing, when a user makes a particular user input in that location. In this way, the user would know which part of the display he or she is using to perform filtered scrolling. A label associated with the filtering criterion may also be briefly displayed upon the user making a particular user input, such as flashing up the label “Gmail”. Alternatively, the label and/or highlighting may remain displayed for the duration of the particular user input.

Further examples include the user being able to make a particular user input in order to perform filtered scrolling by making said input at an appropriately configured location anywhere on the apparatus; the back or sides of the apparatus may be configured to accept user inputs (for example, in the case of touch-sensitive skins or coatings being present on a device).

The above example relates to a list of e-mails in a unified e-mail inbox. It will be appreciated that filtered scrolling need not be limited to a list of e-mails. For example, a user may have a list of all music (either songs or albums) available to an apparatus comprising an electronic device wherein a number of items are displayed on a screen at any time. The device may allow for filtered scrolling according to one or more properties of the music displayed in the full list. For example, the user may wish to scroll through a sub-set of a list of all songs available to listen to. The user may apply a filtering criterion to view only songs falling into a particular filtering category such that a sub-set of songs is scrolled through. Filtering may be performed, by example, by genre, artist, album, year, or directory (for example if some music is stored on the device memory, and other music is stored on a separate removable memory such as an SD card or USB storage device). Other suitable filtering criteria may be envisaged.

Advantages provided by the above example may include that the user need not be concerned with performing two actions, those of separately applying a filter, and scrolling through a list of items. The filtering and scrolling can be performed by a single continuous gesture using the user interface of the apparatus. Using one continuous user input to perform both filtering and scrolling may make the management of items in lists, and searching for a particular item in a list, more intuitive, simpler, and/or faster. Another advantage related to the example above may be that performing a simple single continuous gesture to scroll through a filtered list of e-mails to find a particular e-mail may allow for rapid identification of an e-mail of interest. Further, reduced effort may be required on the part of the user in terms of needing to apply a filter separately to performing a scroll through the filtered list. It will be appreciated that the user input made to filter the list of items may actually be a separate input to a user input made to just scroll through the sub-set of the (filtered) list, or to just scroll through the unfiltered list.

It may be envisaged that the user can perform further actions than just filtered scrolling in a single user input or using a subsequent user input. Thus the user can make multiple inputs as part of the same overall gesture input, or make subsequent discrete inputs after the particular user input made for performing filtered scrolling.

A user may, for example, slide a finger over a particular region of a touch-sensitive region of an apparatus in order to perform filtered scrolling through a list. Without terminating the particular user input of sliding his finger, the user may be able to make further input, for example, to make a selection. Example further inputs (which may make a selection) include tapping a region of the apparatus with the finger used to perform the slide action, and tapping a region of the apparatus with a different finger to the finger used to make the slide input, either during or after the slide. Said tap may be a single or multiple tap, or a tap and hold. Other examples include flicking/swiping the same finger used to slide over a region of the screen used to perform filtered scrolling, either in the same direction as the slide or in a different direction. All such additional inputs, which in these examples provide for selection of a particular item from the filtered list, can be considered as part of the overall gesture input, or could be considered to be a discrete subsequent input.

For example, a user may have performed filtered scrolling of a list of e-mails by sliding his index finger over a particular region of the apparatus in order to scroll through a sub-set of the list of e-mails (e.g. as in the embodiment shown in FIG. 4b or FIG. 4c or in an embodiment where a particular gesture over a list of items creates a predetermined sub-set according to the particular filtering criterion). Upon seeing an e-mail of interest in the sub-set, the user may, for example, be able to (slide his finger over and) flick his index finger to the right to reply to the e-mail, flick his index finger to the left to delete the e-mail, flick his index finger up to move the e-mail to a different storage location, tap with his middle finger on the screen to load the e-mail, double tap with this middle finger to load the contact details of the sender of the e-mail, or tap and hold with his index finger (used for scrolling) to re-filter the list of e-mails according to an aspect of the e-mail of interest, such as date of transmission, sender, subject, etc.

It may also be envisaged that the user can perform a particular user input of sliding a finger over a particular region of the apparatus to scroll through a sub-set of the list of e-mails, and during the slide action (as the sub-set is scrolled through), tap (or hold, press, double tap, etc.) multiple e-mails in the sub-set in order to perform an action on all the (tap) selected e-mails later on. For example, after performing the slide input (for filtered scrolling) and tap inputs (for selecting multiple e-mails), the user may be able to flick his finger which was used for sliding down the list in a particular direction to, for example, delete all the selected items. Many combinations of user input, corresponding action and list-based applications are possible and included within the scope of this disclosure.

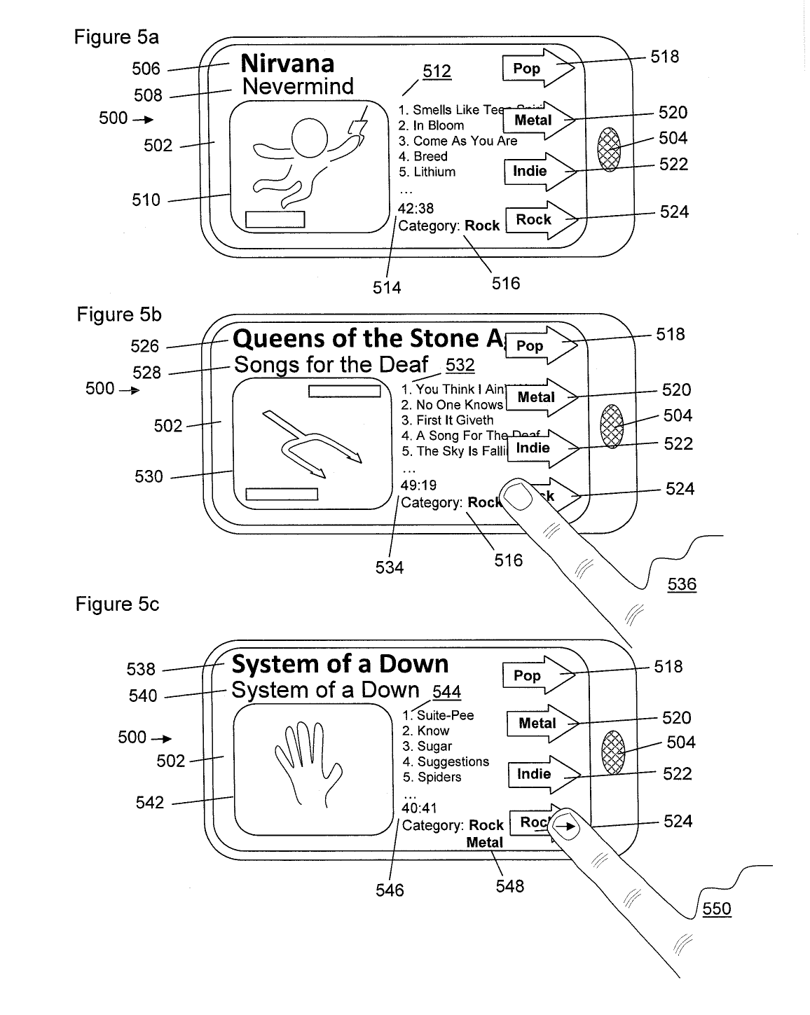

FIGS. 5a-c show an example embodiment of an apparatus which is a portable electronic device 500 in use. In this example, a user wishes to work with a list of items (albums) in a music application. Unlike the previous embodiments, this embodiment does not provide for display all/multiple of the items in the list of items at the same time as receiving/detecting particular user input to provide for scrolling through a filtered sub-set of the list of items.

Hence, FIG. 5a shows an electronic device 500 with a touch-sensitive screen 502 displaying details of an item, in this example an album, which is currently playing through a speaker 504. Details of the displayed item include the artist name 506, the album name 508, an image such as the album cover artwork 510, the track listing 512, the running time 514 and the category 516 which the album is categorised under. An album in this example may be categorised under more than one category, for example, an album may be considered both rock and metal as shown in FIG. 5c 548. The category or categories assigned to each album are properties of the album. As mentioned above, in this example, the list of available albums (that is, the list of items) is not shown on the display. Rather, only one item in the list of items (albums) is displayed on screen at any one time. By scrolling through to a next available album (item), the user can access the content of the list of items/albums.

The user wishes to listen to a different album which it (or otherwise has been) categorised as, or has the property, of being ‘rock’ music. The user therefore needs to scroll through the albums available to the device to find a suitable album. In this example the user has categorised the albums available to the device into four categories: pop, metal, indie and rock. The user interface (the touch-sensitive screen 502) can detect particular user inputs at four particular locations in this example, the particular locations indicated by user interface elements (in this example, arrows) labelled ‘Pop’ 518, ‘Metal’ 520, ‘Indie’ 522 and ‘Rock’ 524. The labels of the user interface elements indicate corresponding filtering criteria.

In FIG. 5b, the apparatus detects that the user is making a particular user input. The particular user input may be made by the user touching his finger 536 at on a user interface element 524 displayed on the user interface 502. The particular user input of touching the “Rock” user interface element 524 has the effect of scrolling through a filtered sub-set of the list of items. This scrolling results in the details of the next ‘rock’ album in the sub-set of all ‘rock’ albums in the list of all albums being displayed. The filtering criterion in this case is to only include albums in the sub-set of the list of items with the property of ‘rock’ 516, 548. The user will not see any albums during filtered scrolling which do not have the property ‘rock’, as all albums in the list of albums which do not meet the filtering criterion of having the property ‘rock’ are excluded from the list (in the sense they are not available for access while the “Rock” user interface element 524 is actuated). The particular user input of touching 536 the user interface element 524 is a single continuous gesture made using the touch sensitive screen of the device.

The details shown of the next album in FIG. 5b are the artist name 526, the album name 528, the album cover artwork 530, the track listing 532, the running time 534 and the property, or category ‘rock’ 516. This next rock album has been displayed given the user actuation of the “Rock” user interface element.

In this example shown in FIG. 5b, the user is providing the particular user input of touching the user interface element 524 to scroll through a filtered sub-set of the list of items. For example, the scrolling speed achieved by providing a touch user input may be a particular rate of, for example, one album or item shown on the screen every five seconds. It may also be envisaged in this example that releasing the touch user input while an album is being displayed will stop the filtered scroll, and automatically begin playing the album.

In the example shown in FIG. 5c, the user is providing the particular user input of a slide across the user interface element from left to right 550. This sliding particular user input in this example 550 allows the device to perform filtered scrolling through the filtered sub-set of the list of items at a faster rate than that achieved when providing a touch particular user input as shown in FIG. 5b. This faster rate may be displaying one item (album) on screen for one to two seconds before moving on to the next album in the filtered list, for example. Again, details of the album are displayed as in FIGS. 5a and 5b (the artist name 538, album name 540, album artwork 542, track listing 544 and running time 546). In this example, releasing the particular user input of sliding a finger across the user interface element 524 automatically starts to play the displayed album. In other embodiments, multiple “Rock” albums may be displayed as a list in one go, for example, such that at least one of these displayed items can be subsequently selected (if required).

The albums in the sub-set of the list of albums in the above examples are all items relating to the same keyword (that of ‘rock’), and may also be considered to all relate to the same subject (rock music).

It may be the case that, rather than user interface elements 518, 520, 522, 524 being displayed, the touch-sensitive display is split into ‘virtual’ strips (or columns, or other areas) so that the user may provide a particular user input to a ‘virtual’ strip/column/area associated with a filtering criterion such as rock, indie, pop or metal, for example. Further, the device may be configured to accept user input in other regions of the device such as the back or sides, and these regions may be configured to act as ‘virtual’ areas allowing particular user inputs to be made and filtered scrolling to be performed.

It may be envisaged that during the filtered scrolling, the previously playing album continues to play until a new choice of album is made. Alternatively, no audio output may be provided during the filtered scrolling.

It may be envisaged that the user input in the above example need not be made by a user's finger, but may be made using a thumb, multiple fingers, a stylus, a scriber, a pointing stick, a wand, a remote control, or other suitable input device. In the case of an exemplary music playing device with a user interface comprising a proximity-sensitive screen, it may be envisaged that the particular user input may be a hover gesture over a user interface element, for example.

In this example the user can only see the details of one item (one album) on screen at any time. It will be appreciated that an indication of the next album in the series of albums on the device may be displayed at the same time as the current album, for example on the left of the screen for the previous album, and on the right of the screen for the next album in the list. The albums may additionally be alphabetically organised. It will be appreciated that different filtered scrolling criterion could be used, for example, artist, running time, and/or frequency of play.

It will be appreciated that many other genres of music and audio exist and may also be used as properties of the albums (such as, for example, opera, jazz, folk, dance, and audio such as spoken word albums, audio books, and language-instruction courses). Such properties may be selected and assigned by the user, or may be predetermined by the device (for example, according to album information included by the recording company).

Advantages relating to the above examples of FIGS. 5b and 5c include that a user can perform at least one of two particular user inputs, detected by the user interface: one of touching the user interface element to perform a slower filtered scroll through the sub-set of ‘rock’ albums, and another of sliding a finger along the user interface element to perform a faster filtered scroll of the same sub-set of items. The user can perform a slower filtered scroll, for example if they wish to read the details of each album, or a faster filtered scroll if they wish to browse the album title only, for example. Each way of performing filtered scrolling requires only one particular user input of a single continuous gesture. In this example also, the user is able to quickly scroll through all albums of a particular genre by performing filtered scrolling according to a particular filtering criterion. The user may thereby find albums of a particular genre which he or she may have forgotten were available to play. In this way the user can experience enhanced enjoyment of their music collection.

FIG. 6 depicts an example embodiment of the apparatus comprising an electronic device 600, e.g. such as a desktop computer or laptop with a user interface comprising peripheral devices, including a display or monitor 602, a mouse 604 and a physical keyboard 606. A user can manipulate the mouse 604 to control the movement of a pointer 608 on screen 602.

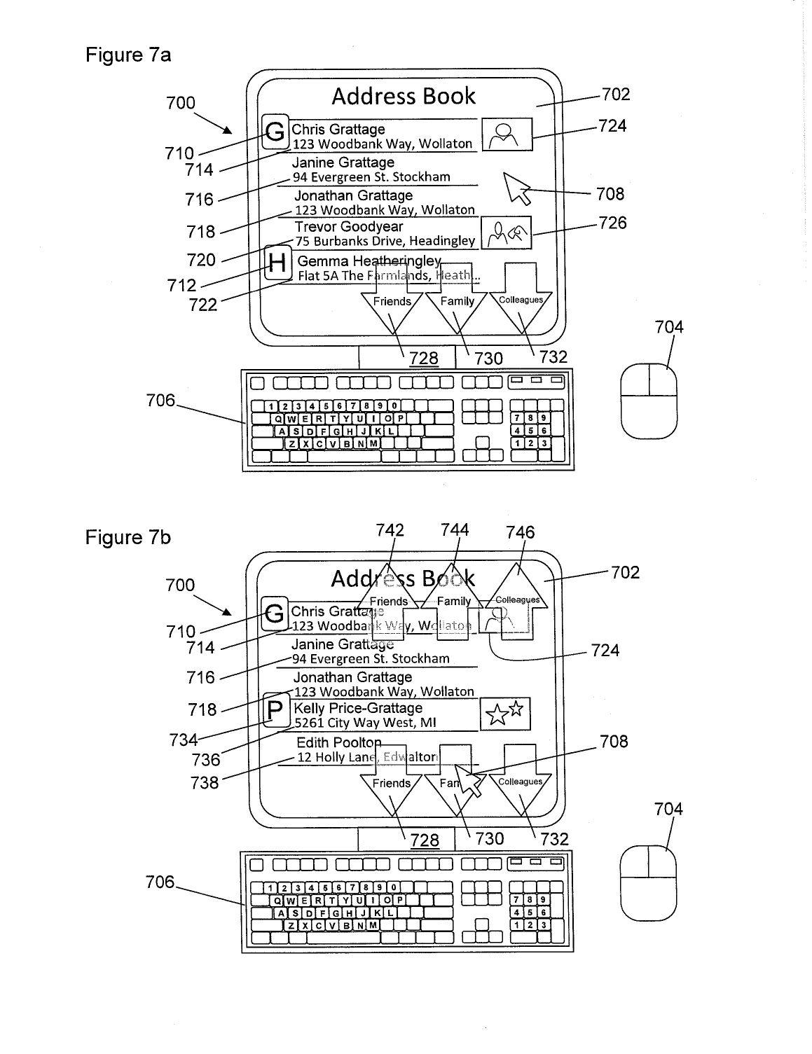

FIGS. 7a-b show an example embodiment of an apparatus which is an electronic device 700 such as that shown in FIG. 6, in use. The mouse 704 (and keyboard 706) provides a user interface for the device. In this example, the device is displaying an address book application on the monitor 702, similar to a contact list. In this example the list of items is a list of contacts 714, 716, 718, 720, 722 displayed in alphabetical order by surname. Some of the items may display an associated image, such as a photograph or avatar 724, 726. In FIG. 7a a portion of the items in the list of contacts is displayed, and to view other entries, the user can scroll through the list of items. There may be hundreds of contacts in the address book in total. The entries may be shown alongside group headings. In this example the entries are displayed alphabetically and the first item in each series of names beginning with the same letter is shown alongside a marker displaying the initial letter (“G” 710 and “H” 712 are shown in FIG. 7a).

The user in this example wishes to contact several family members and wishes to find their contact details using the displayed address book. In this example the user is presented with three possible filtering criteria on user interface elements displayed on the monitor 702, which are “Friends” 728, “Family” 730 and “Colleagues” 732. Each contact in the address book, that is, every item in the list, has a property which is either “Friends” 728, “Family” 730 or “Colleagues” 732, although different or additional properties may be envisaged. Some items may have more than one property.

The user in FIG. 7b is providing a particular user input which is detected by the apparatus. The particular user input is a non-gesture input made via the peripheral device of a mouse 704 connected to the apparatus 700. The particular user input is made by clicking and holding down the mouse button 704 with the pointer 708 located at a particular location on the device. The particular location is a user interface element displaying the filtering criterion “Family” 730. Two other user interface elements are available for the user to interact with: “Friends” 728 and “Colleagues” 732. The particular user input is a single continuous gesture made using the mouse 704, that of pressing and holding the mouse button.

The particular user input causes the apparatus to perform a filtered scroll through a sub-set of the list of items. The sub-set of items is a list of contacts with each contact in the sub-set having the property of “Family”. Therefore contacts which do not have this property do not meet the applied filtering criterion of “Family” and are excluded from the sub-set of the list of items (that is, the contacts 720 and 722 are excluded from the sub-set of the list of items during filtered scrolling as they do not have the property of “Family”). It can be seen that, compared with FIG. 7a, fewer entries are available to be displayed while the filtered scrolling takes place. For example, there are no contacts categorised as family members whose surnames begin with the letters H, I, J, K, L, M, N or O. The next entry not excluded from the filtered list 738 begins with the letter P 736.

As the particular user input is maintained (that is, the mouse button is held down, the filtered sub-set of the list of contacts is scrolled through so that the user is able to view the contact details of the entries classified as “Family” as the list is scrolled through. In this example, the user has the ability to either scroll down the list using the user interface elements located at the bottom of the screen 728, 730, 732 and the ability to scroll up through the list of contacts using the user interface elements located at the top of the screen 742, 744, 746.

It may be envisaged that if the user releases her press on the mouse button, thereby terminating the particular user input, that all the contacts would again be available for display as in FIG. 7a. Alternatively, release of the user input (press) may just stop scrolling through the list, but leave the sub-set of items displayed on the screen.

In this example, the user interface elements displayed on the screen 728, 730, 732 are partially transparent, so that the user can see contact details and information which would be otherwise obscured.

If the list of all contacts in the address book is very long, without being able to filter the information and scroll through it, finding the contact details of interest may be a long task for the user. It may be imagined that, if the user wishes to find a particular person's details in this long list it may be easy to miss by scrolling through all the contact details of everyone held in the address book. Further, the user may wish to also view details of other people who are not family members alongside scrolling though details of family members only. In this case if the user were required to separately apply and un-apply filtering criteria to the list of contacts between scrolling through the lists, the task of finding particular contact details could become fiddly. By being able to perform filtered scrolling via a single user input, the user may be able to work with the list of items in the address book more easily and/or quickly.

The filtering categories available in the exemplary address book example above need not only be by “Friends”, “Family” and “Colleagues”. For example, the user may also have some contact details which are associated with social media accounts. Therefore the user can perform filtered scrolling according to social media criteria such as by “Facebook” (thereby displaying the sub-set of users with an associated Facebook account), “Twitter”, or “LinkedIn”, for example. In this way a user may perform filtered scrolling to browse her contacts associated with work (by using a “colleagues” and/or “LinkedIn” filtering criterion, and out-of-work activities (for example, by using a “Friends” and/or “Facebook” filtering criterion.

A further example embodiment may be envisaged of an apparatus which is a portable electronic device comprising multiple Subscriber Identity Module (SIM) card functionality. The device may have, for example, dual SIM functionality where two SIM cards can be used with the device at any time. The user of such as device may have multiple SIM cards for use with the portable electronic device. Using such a device, the user may be able to perform filtered scrolling through an address book application on the portable electronic device by filtering according to the SIM card(s) in operation with the device at the time of the filtered scrolling. For example, the user may have two SIM cards in use in a dual SIM device: one SIM card, called SIMUK for example, for use in the UK and on which the user has stored the contact details of his contacts based in the UK, and another SIM card, called SIMFrance for example, for use in France and on which the user has stored the contact details of his contacts based in France. The user may be able to perform filtered scrolling through the list of contacts available to the device comprising the contacts stored on SIMUK and SIMFrance, by providing a particular user input allowing the user to scroll through the sub-set of the list of contacts associated with the SIMUK (or the SIMFrance) card, for example. Such filtered scrolling would be useful, for example, in identifying the contact details of contacts registered in a particular country. If the user uses a particular SIM card to store contacts based in a particular country, and wishes to find details of, for example, a French contact whose details are stored on the user's SIMFrance SIM card, they are able to scroll through a sub-set of all contacts available to the device, the sub-set being a list of items matching the criterion of being stored on the SIMFrance SIM card.

Performing filtered scrolling on a device filtered by SIM card may also be performed when managing entries on a list of all calls logged by the device. For example, a call log application on the device may keep a log of all calls received, made, missed, diverted etc. by the phone. The various calls may be associated with different contacts whose details are stored on different SIM cards. The user may be able to perform filtered scrolling through the call log list of entries to scroll through the sub-set of the list of entries associated with a particular SIM card. For example, if the user of the device has one SIM card for personal use, and another SIM card for business use, the user may wish to perform filtered scrolling in order to view the call log for, for example, business related calls only, by filtering the list according to the criterion of calls relating to the business SIM card in use in the device.

Another example embodiment of an apparatus comprises a device capable of running a calendar application in which multiple calendars may be managed in the application. A user may be able to provide particular user inputs to particular locations on the user interface of the device, each location being associated with allowing the user to scroll through a sub-set of the calendar entries which meet a particular filtering criterion. For example, providing a particular user input in one area of the user interface may allow the user to scroll through the sub-set of calendar entries which are related to the user's work calendar, perhaps by being synchronised (i.e. linked) to the user's work calendar. Providing a particular user input in a different area of the user interface may allow the user to scroll through the sub-set of calendar entries which are related to a different network based calendar such as a social networking application calendar. The user may also be able to scroll through a sub-set of calendar entries which are not associated or synchronised with a network calendar, and which are stored directly on the device, for example, again using a particular user input at a particular location.

Another example embodiment of an apparatus comprises a device capable of running a social media application in which notifications are displayed to notify the user of events taking place in the user's social media space/homepage. Notifications may alert the user that a contact has updated his or her status, location, or photo; that a contact has sent a direct message to the user; that a contact has uploaded some photographs or a movie for the user to view, or has performed another action. A user may be able to provide particular user inputs to particular locations on the user interface of the device, each location being associated with allowing the user to scroll through a sub-set of one category/type of notification on the user's social media page. The locations on the device may be columns or rows/strips across a touch-sensitive screen or areas of the back/sides of the device configured to accept user input. For example, the user may be able to scroll through a list of notifications filtered by contact (so that only notifications from a particular contact are shown), filtered by type of notification (uploaded content, status update, event invitation, etc.), or other filtering criterion. It may further be envisaged that the user has several social media accounts, each sending the user a notification of any change in their social media space/homepage. In this example, the user may be able to perform filtered scrolling to scroll through a sub-set of notifications filtered by the social media service in which the notification was made (e.g. filter by Facebook, Twitter, MySpace, LinkedIn, etc.) by providing the particular user input in a region associated with the particular social media service.

Example embodiments may provide feedback to the user that a particular user input has been appropriately applied in order to perform filtered scrolling. The feedback may comprise, for example, a first feedback signal provided to the user by the apparatus when the user provides a particular user input to one user interface element/particular location in order to scroll through a sub-set of items filtered according to one criterion. A second (different) feedback signal could be provided to the user by the apparatus when the user provides a particular user input to another (different) user interface element/particular location in order to scroll through a sub-set of items filtered according to a different filtering criterion.

For example, the user may wish to scroll through a list of notifications received from several networking services using an exemplary apparatus comprising a device, itself comprising a touch-sensitive screen and a speaker. The device may be configured to sound an audio signal to indicate which items are displayed (e.g. using speech output, or sounding a tone or beep, via the speaker.) By providing a particular user input to one user interface element (such as a region/column/strip of a touch-sensitive screen) of the device, the device may filter the list of notifications to recite only those entries associated with one particular networking service, and also provide tactile feedback so that the user is aware that the sub-set of the list of items being recited is a result of filtering a list of items relating to several networking services. The user may alternatively provide particular user input to respective different user interface elements to filter the list according to a respective different networking service. The feedback indications provided may be user configurable, and/or may be determined by the device (for example, according to the output capabilities of the apparatus). Providing feedback in this way may provide a heads-up way for a user to use such an apparatus, where a user may be informed of the input being made and the result of that input on the information displayed by the apparatus.

It will be appreciated that in the examples described herein, a user may be allowed to make user input other than to perform filtered scrolling. For example, in viewing a filtered sub-set, or list, of e-mails, the user may be able to perform user inputs to manage the items in the sub-set/list once the scrolling has ended. Such input may allow a user to reply to, delete, forward, flag, move, or otherwise perform an operation on an item in the sub-set/list.

It will be appreciated that the lists of items can be associated with, for example, an e-mail application, a music application, and a contact list/address book application. It will be appreciated that other example embodiments may be envisaged relating to lists of items, each item comprising a property, and each list of items being associated with a messaging application, a calendar, a microblogging application, a social networking application, a music application, a marketplace application, a television application, a movie application, a photo application, a navigating application, a dictionary application, an e-book application, or another application involving a list of items.

Certain embodiments described herein feature the use of particular user inputs, namely particular user inputs comprising a touch, a swipe, a slide, and a press/hold (of a mouse button). These particular user inputs can be single continuous gestures made using the user interface to allow the apparatus to perform filtered scrolling. Other particular user inputs may be envisaged which are also single continuous gestures made using the user interface, such as a rotate gesture, a static hover gesture proximal to the device, a moving hover gesture proximal to the device, bending at least part of the device, squeezing at least part of the device, a multi-finger gesture, tilting the device, and flipping the device. Other particular user inputs may be envisaged which are single non-gesture continuous inputs made using the user interface, such as clicking a mouse button, pressing a physical key, pressing a physical button, rotating a wheel or moving a trackball.

It will be appreciated that, according to the embodiments in question, a sub-set of items may comprise one or more of items relating to the same application; items relating to the same recipient; items relating to the same sender; items comprising the same key word; items relating to the same user; items relating to the same subject; or items being associated with the same importance level.

It will be appreciated that, according to the embodiments in question, user interfaces may comprise one or more of a touchpad, a touch-screen, a stylus and pad, a virtual keyboard, a virtual button, a symbol, a scriber, an accelerometer, a wand, a pointing stick, a mouse, a physical keyboard, a joystick, a remote controller, a physical button, a motion detector, or a position detector.

It will be appreciated that in the previously described embodiments associated with FIGS. 4, 5 and 7, at least one item from a list of items is being displayed (whether the full list is being displayed, or provided for display e.g. ready access to scrolling possible to reveal hidden items if all the items in the list do not fit on the display) at the time of detecting a user input which provides for filtered scrolling associated with the list of items. It may be

It will be appreciated that the apparatus may be an electronic device, a portable electronic device, a laptop computer, a desktop computer, a mobile phone, a Smartphone, a tablet computer, a monitor, a personal digital assistant, a digital camera, a watch, a server, or a module/circuitry for one or more of the same.

It will be appreciated that a suitable lists of items which may be operated on according to one or more examples described herein may be an e-mail application, a contact list, an address book, a messaging application, a calendar, a microblogging application, a social networking application, a music application, a marketplace application, a television application, a movie application, a photo application, a navigating application, a dictionary application, an e-book application, or another application involving a list of items.

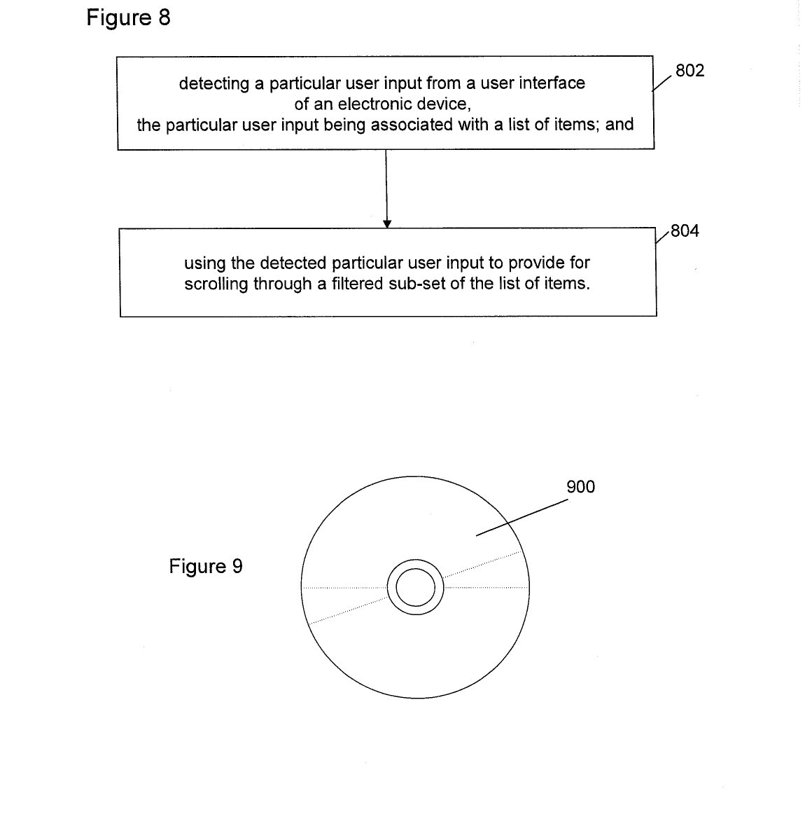

FIG. 8 shows a flow diagram illustrating the steps of providing for scrolling through a filtered set of list items in steps 802 and 804, and is self-explanatory.

FIG. 9 illustrates schematically a computer/processor readable medium 900 providing a program according to an embodiment of the present disclosure. In this example, the computer/processor readable medium is a disc such as a digital versatile disc (DVD) or a compact disc (CD). In other embodiments, the computer readable medium may be any medium that has been programmed in such a way as to carry out an inventive function. The computer program code may be distributed between the multiple memories of the same type, or multiple memories of a different type, such as ROM, RAM, Flash, hard disk, solid state, etc.

It will be appreciated to the skilled reader that any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

It will be appreciated that the term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out example embodiments, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
detect a particular user input from a user interface of an electronic device, the particular user input being associated with a list of items; and
use the detected particular user input to provide for scrolling through a filtered sub-set of the list of items.

2. The apparatus of claim 1, wherein the filtered sub-set comprises a sub-set of the list of items in which particular items have been excluded from the list of items in order to provide the sub-set, the exclusion of items determined according to a filtering criterion.

3. The apparatus of claim 1, wherein filtered scrolling is based upon a filtering criterion which is determined according to a property of at least one item in the list of items.

4. The apparatus of claim 3, wherein the property of at least one item comprises a property of at least one item in a list of items associated with an e-mail application, a contact list, an address book, a messaging application, a calendar, a microblogging application, a social networking application, a music application, a marketplace application, a television application, a movie application, a photo application, a navigating application, a dictionary application, an e-book application, or another application involving a list of items.

5. The apparatus of claim 1, wherein the particular user input is a single continuous gesture made using the user interface.

6. The apparatus of claim 1 wherein the particular user input is a gesture which comprises one or more of a tap, a swipe, a slide, a press, a hold, a rotate gesture, a static hover gesture proximal to the user interface of the device, a moving hover gesture proximal to the device, bending at least part of the device, squeezing at least part of the device, a multi-finger gesture, tilting the device, or flipping the device.

7. The apparatus of claim 1 wherein the particular user input is a non-gesture input comprising clicking or pressing a mouse button, pressing a physical key, pressing a physical button, rotating a wheel or moving a trackball.

8. The apparatus of claim 1, wherein a filtering criterion provides a sub-set of items, the sub-set of items comprising one or more of:
items relating to the same application;
items relating to the same recipient;
items relating to the same sender;
items comprising the same key word;
items relating to the same user;
items relating to the same subject; or
items being associated with the same importance level.

9. The apparatus of claim 1, wherein the apparatus is configured to provide additional alphabetisation grouping of the filtered sub-set of the list of items.

10. The apparatus of claim 1, wherein the particular user input is associated with one or more particular locations on the user interface of the electronic device.

11. The apparatus of claim 10, wherein the one or more particular locations comprise one or more of columns, rows, or areas of the user interface of the electronic device.

12. The apparatus of claim 1, wherein the user interface of the electronic device comprises one or more of a touchpad, a touch-screen, a stylus and pad, a virtual keyboard, a virtual button, a symbol, a scriber, an accelerometer, a wand, a pointing stick, a mouse, a physical keyboard, a joystick, a remote controller, a physical button, a motion detector, or a position detector.

13. The apparatus of claim 1, wherein the user interface of the electronic device comprises one or more user interface elements associated with receipt of the particular user input, the user interface element comprising an indicator, an icon, a physical key, a menu item, or a particular region on a touch-sensitive user interface.

14. The apparatus of claim 1 wherein a filtering criterion for filtering the list of items is at least one of user selectable, or predetermined by the device.

15. The apparatus of claim 1, wherein the apparatus is an electronic device, a portable electronic device, a laptop computer, a desktop computer, a mobile phone, a Smartphone, a tablet computer, a monitor, a personal digital assistant, a digital camera, a watch, a server, or a module/circuitry for one or more of the same.

16. The apparatus of claim 1, wherein at least one item from the list of items is displayed by the electronic device at the time of detecting the particular user input which provides for filtered scrolling associated with the list of items.

17. The apparatus of claim 1, wherein at least two items from the list of items is displayed by the electronic device at the time of detecting the particular user input which provides for filtered scrolling associated with the list of items.

18. A method, the method comprising:
detecting a particular user input from a user interface of an electronic device, the particular user input being associated with a list of items; and
using the detected particular user input to provide for scrolling through a filtered sub-set of the list of items.

19. A computer readable medium comprising computer program code stored thereon, the computer readable medium and computer program code being configured to, when run on at least one processor, perform at least the following:
detect a particular user input from a user interface of an electronic device, the particular user input being associated with a list of items; and
use the detected particular user input to provide for scrolling through a filtered sub-set of the list of items.
